(19) United States
(12) Patent Application Publication
(10) Pub. No.: US 2022/0221781 A1
(43) Pub. Date: Jul. 14, 2022

(54) PRINTING SYSTEM USING A PROJECTION DEVICE

(71) Applicant: OSWAL, Ashok, Ludhiana (IN)

(72) Inventor: Ashok Oswal, Punjab (IN)

(21) Appl. No.: 17/611,271

(22) PCT Filed: May 13, 2020
(86) PCT No.: PCT/IB2020/054519

§ 371 Date: Nov. 15, 2021

(30) Foreign Application Priority Data
May 17, 2019 (IN) 201911019502

(51) Int. Cl. G03B 27/52; B41J 3/36

(52) U.S. Cl. CPC G03B 27/522; B41J 3/36

(57) ABSTRACT

A printing system (100) comprising a projecting device (200) configured to project a digital content. The device (200) includes a memory (102) for storing instructions, a processor (104) coupled to the memory (102), an input unit (106) configured to receive at least one input corresponding to the digital content from a user, a digital content processing unit (110) configured to process the digital content, a sensing unit (112) configured to monitor an ambient environment conditions, and a projecting unit (114) configured to project the processed digital content; and a printable substrate (202) configured to receive and imprint the projected digital content from the projecting device (200).

### TECHNICAL FIELD

The present disclosure relates to printing technology, and more particularly to a system and device for performing a printing operation without actually using a conventional printer device.

### BACKGROUND

Printing has existed for hundreds of years and has become a vital part of business and personal use. Its evolution from the first printing press to modern-day digital printers has affected millions, and is most likely to continue to do so. Printing has become a huge business, with several multinational corporations manufacturing printers, their accessories and providing services related to the same.

The Electronic Printing industry has seen waves of change since the first printer which was modeled on electric typewriters, followed by Line Printers, Dot-Matrix systems, inkjets, laser printers, which still constitute a majority of printing devices used for personal or commercial purposes and finally the rise of 3D printing, which is still in a nascent stage.

Similarly, the input methodology for printers has also evolved constantly, in sync with the evolution of computers themselves. While earlier a printer would have to be attached to a personal computer through one or more wires/cables, advancements in technology brought about wireless connectivity which allowed devices to command printers remotely, over Local Area Networks. Printers are required to be connected to the LAN through Ethernet or Wi-Fi, while the portable devices such as computers or mobile phones must be connected to the internet in order to be initiate print jobs to the printer.

The ever-growing need of human beings to strive for better technology for more convenience is discernible in this industry as well. This specially holds true when a high standard of portability and at the same time the capability to function while not connected to the Internet or a LAN hasn't yet been achieved for printers. Even paper jams and cartridge replacements affect day-to-day productivity.

These problems may not seem significant for most offices/households presently, but when viewed from a perspective of accessibility for people and businesses from all geographies and stages of technological development, there exists a striking requirement for a minimalist approach, aimed at the elimination of as many avoidable pre-requisites of completing a printing job, in our way forward.

### OBJECTS OF THE PRESENT DISCLOSURE

Some of the objects of the present disclosure, which at least one embodiment herein satisfies are as listed herein below.

It is an object of the present disclosure to provide a system and device for performing a printing operation without actually using a conventional printer device.

It is another object of the present disclosure to provide a printable substrate capable of imprinting based upon receipt of projections.

It is another object of the present disclosure to provide a device configured for projecting digital content over a printable substrate for printing.

It is another object of the present disclosure to provide a device capable of projecting digital content over a printable substrate as thermal projecting rays or photon projecting rays.

It is another object of the present disclosure to provide a device that can modify the characteristics of the projecting rays based upon ambient environmental conditions like temperature, humidity, etc.

It is another object of the present disclosure to provide a direct printing system capable of working without wired or wireless connection.

It is another object of the present disclosure to provide a direct printing system capable of working without an internet or email platform.

It is yet another object of the present disclosure to provide a printing system and device that is cost effective and easy to implement.

### SUMMARY

The present disclosure relates to printing technology, and more particularly to a system and device for performing a printing operation without actually using a conventional printer device.

An aspect of the present disclosure relates to a direct printing system (100) that includes a projecting device (200) configured to project a digital content. The device (200) includes a memory (102) for storing instructions, a processor (104) coupled to the memory (102), an input unit (106) configured to receive at least one input from a user, an digital content processing unit (110) configured to process the digital content, a sensing unit (112) configured to monitor an ambient environment condition, and a projecting unit (114) configured to project the processed digital content; and a printable substrate (202) configured to receive and imprint the projected digital content from the projecting device (200).

In an aspect, the digital content is any or a combination an image, a document.

In an aspect, the device (200) includes an imaging unit (108) configured to capture an image based upon the input from the user.

In an aspect, the projecting device (200) is any or a combination of a smart phone, camera.

In an aspect, the input unit (106) provides an interface to the user for providing the at least one input.

In an aspect, the digital content processing unit (110) is configured to evaluate pixel data based upon processing of the digital content.

In an aspect, the sensing unit (112) includes a plurality of sensors for monitoring the ambient environment condition, the ambient environment condition is any or a combination of light, temperature, pressure, humidity, distance.

In an aspect, the projecting unit (114) includes a thermal projection sub-unit (114a) and a photonic projection sub-unit (114b).

In an aspect, the printable substrate (202) is any or a combination of a carbonized paper, photosensitive paper.

In an aspect, the projecting unit (114) is configured to project any or a combination of thermal projection rays, a photonic projection rays on to the printable substrate (202), wherein a selection of the projection rays is based upon inputs from the digital content processing unit (110) and the sensing unit (112).

In another aspect, the present disclosure relates to a projecting device (200) configured to project a digital content, said device (200) includes a memory (102) for storing instructions, a processor (104) coupled to the memory (102), an input unit (106) configured to receive at least one input from a user, an digital content processing unit (110) configured to process the digital content, a sensing unit (112) configured to monitor an ambient environment condition, and a projecting unit (114) configured to project the processed digital content, wherein, the projecting device (200) is configured to project the processed digital content on to a printable substrate (202) configured to receive and imprint the projected digital content.

In another aspect, the projecting unit (114) includes a thermal projection sub-unit (114a) and a photonic projection sub-unit (114b), and the printable substrate (202) is any or a combination of a carbonized paper, photosensitive paper, and wherein the projecting unit (114) is configured to project any or a combination of a thermal projection rays, a photonic projection rays on to the printable substrate (202), wherein a selection of the projection rays is based upon inputs from the digital content processing unit (110) and the sensing unit (112).

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an environment where a direct printing system 100, hereinafter referred to as system 100, is implemented in accordance with an embodiment of the present disclosure.

FIG. 2 illustrates a block diagram depicting functional modules of the projecting device 200 in accordance with an embodiment of the present disclosure.

FIG. 3 illustrates a direct printing method 300 in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein may be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosure relates to printing technology, and more particularly to a system and device for performing a printing operation without actually using a conventional printer device.

An aspect of the present disclosure relates to a direct printing system (100) that includes a projecting device (200) configured to project a digital content. The device (200) includes a memory (102) for storing instructions, a processor (104) coupled to the memory (102), an input unit (106) configured to receive at least one input from a user, an digital content processing unit (110) configured to process the digital content, a sensing unit (112) configured to monitor an ambient environment condition, and a projecting unit (114) configured to project the processed digital content; and a printable substrate (202) configured to receive and imprint the projected digital content from the projecting device (200).

In an aspect, the digital content is any or a combination an image, a document.

In an aspect, the device (200) includes an imaging unit (108) configured to capture an image based upon the input from the user.

In an aspect, the projecting device (200) is any or a combination of a smart phone, camera.

In an aspect, the input unit (106) provides an interface to the user for providing the at least one input.

In an aspect, the digital content processing unit (110) is configured to evaluate pixel data based upon processing of the digital content.

In an aspect, the sensing unit (112) includes a plurality of sensors for monitoring the ambient environment condition, the ambient environment condition is any or a combination of light, temperature, pressure, humidity, distance.

In an aspect, the projecting unit (114) includes a thermal projection sub-unit (114a) and a photonic projection sub-unit (114b).

In an aspect, the printable substrate (202) is any or a combination of a carbonized paper, photosensitive paper.

In an aspect, the projecting unit (114) is configured to project any or a combination of thermal projection rays, a photonic projection rays on to the printable substrate (202), wherein a selection of the projection rays is based upon inputs from the digital content processing unit (110) and the sensing unit (112).

In another aspect, the present disclosure relates to a projecting device (200) configured to project a digital content, said device (200) includes a memory (102) for storing instructions, a processor (104) coupled to the memory (102), an input unit (106) configured to receive at least one input from a user, an digital content processing unit (110) configured to process the digital content, a sensing unit (112) configured to monitor an ambient environment condition, and a projecting unit (114) configured to project the processed digital content, wherein, the projecting device (200) is configured to project the processed digital content on to a printable substrate (202) configured to receive and imprint the projected digital content.

In another aspect, the projecting unit (114) includes a thermal projection sub-unit (114a) and a photonic projection sub-unit (114b), and the printable substrate (202) is any or a combination of a carbonized paper, photosensitive paper, and wherein the projecting unit (114) is configured to project any or a combination of a thermal projection rays, a photonic projection rays on to the printable substrate (202), wherein a selection of the projection rays is based upon inputs from the digital content processing unit (110) and the sensing unit (112).

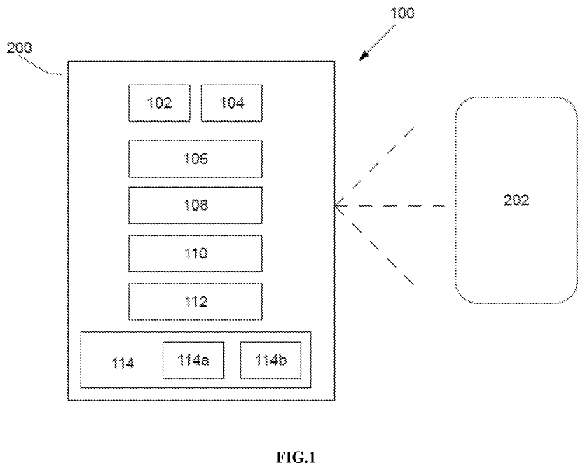

FIG. 1 illustrates an environment where a direct printing system 100, hereinafter referred to as system 100, is implemented in accordance with an embodiment of the present disclosure.

In an embodiment, the system 100 includes a projecting device (200) configured to project a digital content. In an example, the projecting device 200 is any or a combination of a smart phone, camera.

In an embodiment, the projecting device 200 includes a memory 102 for storing instructions, and a processor 104 coupled to the memory 102. The projecting device 200 further includes an input unit 106 configured to receive at least one input from a user of the projecting device 200. In an example, the input unit 106 provides an interface to the user for providing the at least one input. In an example, the input may include clicking an image, accessing an image, accessing a document, preparing a document, etc. In an embodiment, content associated with the image, or document mentioned above may be qualified as the digital content. Accordingly, digital content may include text, images, graphics, etc.

In an embodiment, the projecting device 200 further includes a digital content processing unit 110 configured to process the digital content. In an example, the digital content processing unit 110 is configured to evaluate pixel data based upon processing of the digital content. Further, the projecting device 200 includes a sensing unit 112 configured to monitor an ambient environment condition. In an example, the sensing unit 112 includes a plurality of sensors for monitoring the ambient environment condition, the ambient environment condition is any or a combination of light, temperature, pressure, humidity, distance.

In an embodiment, the projecting device 200 further includes a projecting unit 114 configured to project the processed digital content based upon the evaluated pixel data. The projecting unit 114 includes a thermal projection sub-unit 114a and a photonic projection sub-unit 114b. In an embodiment, the system 100 further includes a printable substrate 202 provided proximally to the projecting device 200. In an example, the printable substrate 202 is any or a combination of a carbonized paper, photosensitive paper. In an embodiment, printable substrate 202 configured to receive and imprint the projected digital content from the projecting device 200.

In an embodiment, the projecting unit 114 is configured to project any or a combination of thermal projection rays, a photonic projection rays on to the printable substrate 202, wherein a selection of the projection rays is based upon inputs from the digital content processing unit 110 and the sensing unit 112. The thermal projection rays may be heat rays, and the photonic projection rays may include high velocity photons. The projection rays are based upon the evaluated pixel data associated with the digital content, and such projection rays are configured to be received by the printable substrate 202 such that the digital content is imprinted on the printable substrate 202. In an example, characteristics associated with the projection rays such as intensity, radiation, distance, focus, etc. are configurable in real time, and are based upon inputs from the digital content processing unit 110 and the sensing unit 112. In an embodiment, the projecting device 200 also includes a power unit for powering various aforementioned components. The power unit may be an AC or DC powered source.

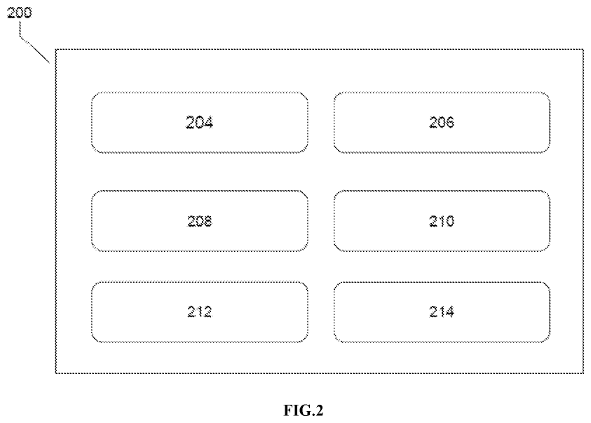

FIG. 2 illustrates a block diagram depicting functional modules of the projecting device 200 in accordance with an embodiment of the present disclosure.

In an aspect, the device 200 may comprise one or more hardware processor(s) 104. The one or more hardware processor(s) 104 may be implemented as one or more microprocessors, microcomputers, microcontrollers, digital signal processors, central processing units, logic circuitries, and/or any devices that manipulate data based on operational instructions. Among other capabilities, the one or more hardware processor(s) 104 are configured to fetch and execute computer-readable instructions stored in a memory 102 of the device 200. The memory 102 may store one or more computer-readable instructions or routines, which may be fetched and executed to create or share the data units over a network service. The memory may comprise any non-transitory storage device including, for example, volatile memory such as RAM, or non-volatile memory such as EPROM, flash memory, and the like.

The device 200 also includes an interface(s). The interface(s) may comprise a variety of interfaces, for example, interfaces for data input and output devices, referred to as I/O devices, storage devices, and the like. The interface(s) may facilitate communication of device 200 with the users, and also other devices. The interface(s) may also provide a communication pathway for one or more components of the device 200. Examples of such components include, but are not limited to, processing engine(s) and data.

The processing engine(s) may be implemented as a combination of hardware and programming (for example, programmable instructions) to implement one or more functionalities of the processing engine(s). In examples described herein, such combinations of hardware and programming may be implemented in several different ways. For example, the programming for the processing engine(s) may be processor executable instructions stored on a non-transitory machine-readable storage medium and the hardware for the processing engine(s) may comprise a processing resource (for example, one or more processors), to execute such instructions. In the present examples, the machine-readable storage medium may store instructions that, when executed by the processing resource, implement the processing engine(s). In such examples, the device 200 may comprise the machine-readable storage medium storing the instructions and the processing resource to execute the instructions, or the machine-readable storage medium may be separate but accessible to the device 200 and the processing resource. In other examples, the processing engine(s) may be implemented by electronic circuitry.

The data may comprise data that is either stored or generated as a result of functionalities implemented by any of the components of the processing engine(s).

In an aspect, the device 200 includes an input module 204, a digital content processing module 206, a sensing module 208, a projecting module 210, an imaging module 212, and a power module 214 amongst other modules.

It would be appreciated that modules being described are only exemplary modules and any other module or sub-module may be included as part of the device 200. These modules too may be merged or divided into super-modules or sub-modules as may be configured.

Functionalities of various modules as mentioned above will now be described in detail in the foregoing description in accordance with an embodiment of the present disclosure. In an embodiment, the various modules mentioned above enables the device 200 for managing and optimizing delivery networks in accordance with an embodiment of the present disclosure.

In an embodiment, the input module 204 is configured with the input unit 106 configured to receive at least one input from the user of the projecting device 200. In an example, the input unit 106 provides an interface to the user for providing the at least one input. The digital content processing module 206 is configured with the digital content processing unit 110 configured to process the digital content. The digital content processing unit 110 is configured to evaluate pixel data based upon processing of the digital content.

Further, the sensing module 208 is configured with the sensing unit 112 configured to monitor an ambient environment condition. The sensing unit 112 includes a plurality of sensors for monitoring the ambient environment condition, the ambient environment condition is any or a combination of light, temperature, pressure, humidity, distance. Further, the projecting module 210 is configured with the projecting unit 114 configured to project the processed digital content based upon the evaluated pixel data. The projecting unit 114 includes a thermal projection sub-unit 114a and a photonic projection sub-unit 114b.

In an embodiment, the projecting unit 114 is configured to project any or a combination of thermal projection rays, a photonic projection rays on to the printable substrate 202, wherein a selection of the projection rays is based upon inputs from the digital content processing unit 110 and the sensing unit 112. The projection rays are based upon the evaluated pixel data associated with the digital content, and such projection rays are configured to be received by the printable substrate 202 such that the digital content is imprinted on the printable substrate 202. In an example, characteristics associated with the projection rays such as intensity, radiation, distance, focus, etc. are configurable in real time, and are based upon inputs from the digital content processing unit 110 and the sensing unit 112. In an embodiment, the projecting device 200 also includes the power module 214 configured with the power unit for powering various aforementioned components and modules. The power unit may be an AC or DC powered source.

In an example, the device 200 may also include the imaging module 212 configured with a camera of the device 200. In an example, the imaging module 212 captures a live image and provides it as an input to the input module 204 for processing, and further printing on the printable substrate 202.

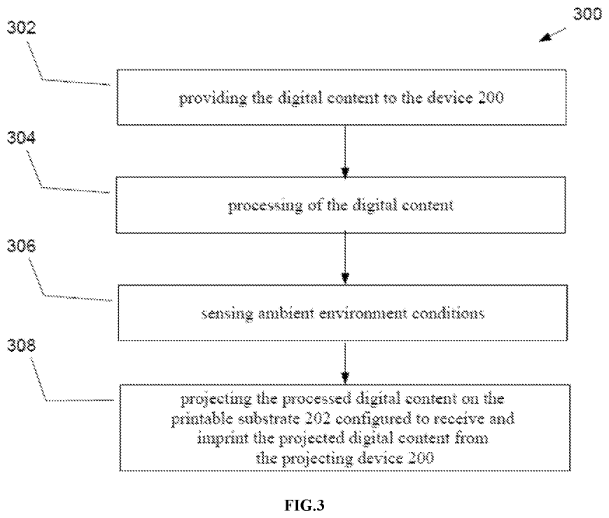

FIG. 3 illustrates a direct printing method 300 in accordance with an embodiment of the present disclosure.

In an aspect, the proposed method may be described in general context of computer executable instructions. Generally, computer executable instructions can include routines, programs, objects, components, data structures, procedures, modules, functions, etc., that perform particular functions or implement particular abstract data types. The method can also be practiced in a distributed computing environment where functions are performed by remote processing devices that are linked through a communications network. In a distributed computing environment, computer executable instructions may be located in both local and remote computer storage media, including memory storage devices.

The order in which the method as described is not intended to be construed as a limitation, and any number of the described method blocks may be combined in any order to implement the method or alternate methods. Additionally, individual blocks may be deleted from the method without departing from the spirit and scope of the subject matter described herein. Furthermore, the method may be implemented in any suitable hardware, software, firmware, or combination thereof. However, for ease of explanation, in the embodiments described below, the method may be considered to be implemented in the above described system.

In an embodiment, at step 302 the method 300 includes, providing the digital content to the device 200. At step 304 the method 300 includes, processing of the digital content. At step 306 the method 300 includes, sensing ambient environment conditions. At step 308 the method 300 includes, projecting the processed digital content on the printable substrate 202 configured to receive and imprint the projected digital content from the projecting device 200.

Although the proposed system has been elaborated as above to include all the main parts, it is completely possible that actual implementations may include only a part of the proposed modules/engines or a combination of those or a division of those in various combinations across multiple devices that can be operatively coupled with each other, including in the cloud. Further the modules/engines can be configured in any sequence to achieve objectives elaborated. Also, it can be appreciated that proposed system can be configured in a computing device or across a plurality of computing devices operatively connected with each other, wherein the computing devices can be any of a computer, a laptop, a smart phone, an Internet enabled mobile device and the like. All such modifications and embodiments are completely within the scope of the present disclosure.

In an implementation, the proposed system 100, discussed above, can be embedded with/incorporated with one or more Internet of Things (IoT) devices. In a typical network architecture of the present disclosure can include a plurality of network devices such as transmitter, receivers, and/or transceivers that may include one or more IoT devices. An IOT device consisting of a Gateway (any Wi-Fi SOC) coupled with projecting device 200. Each such device has a LED display and QR code (or NFC, RFID) associated with it.

As used herein, the IoT devices can be a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a Wi-Fi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using Zigbee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). A wired network may include any wired interface (e.g., fiber, Ethernet, powerline, Ethernet over coaxial cable, digital signal line (DSL), or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network 100 using particular communications protocols, such as WiFi™ (e.g., IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point, Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

As in a typical network architecture of the present disclosure can include a plurality of network devices such as transmitter, receivers, and/or transceivers that may include one or more Internet of Things (IOT) devices. As used herein, an IOT devices can be a device that includes sensing and/or control functionality as well as a Wi-Fi transceiver radio or interface, a Bluetooth transceiver radio or interface, a Zigbee transceiver radio or interface, an Ultra-Wideband (UWB) transceiver radio or interface, a Wi-Fi Direct transceiver radio or interface, a Bluetooth Low Energy (BLE) transceiver radio or interface, and/or any other wireless network transceiver radio or interface that allows the IOT device to communicate with a wide area network and with one or more other devices. In some embodiments, an IOT device may include a cellular transceiver radio, and may be configured to communicate with a cellular network using the cellular network transceiver radio.

Embodiments of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable people having ordinary skill in the art to make and use the invention when combined with information and knowledge available to the person having ordinary skill in the art.

### Advantages of the Present Disclosure

The present disclosure provides a system and device for performing a printing operation without actually using a conventional printer device.

The present disclosure provides a printable substrate capable of imprinting based upon receipt of projections.

The present disclosure provides a device configured for projecting digital content over a printable substrate for printing.

The present disclosure provides a device capable of projecting digital content over a printable substrate as thermal projecting rays or photon projecting rays.

The present disclosure provides a device that can modify the characteristics of the projecting rays based upon ambient environmental conditions like temperature, humidity, etc.

The present disclosure provides a direct printing system capable of working without wired or wireless connection.

The present disclosure provides a direct printing system capable of working without an internet or email platform.

The present disclosure provides a printing system and device that is cost effective and easy to implement.

I claim:

1. A direct printing system (100) comprising:
a projecting device (200) configured to project a digital content, said device (200) includes:
a memory (102) for storing instructions,
a processor (104) coupled to the memory (102),
an input unit (106) configured to receive at least one input corresponding to the digital content from a user,
a digital content processing unit (110) configured to process the digital content,
a sensing unit (112) configured to monitor an ambient environment condition, and
a projecting unit (114) configured to project the processed digital content; and
a printable substrate (202) configured to receive and imprint the projected digital content from the projecting device (200).

2. The system (100) as claimed in claim 1, wherein the digital content is any or a combination an image, a document.

3. The system (100) as claimed in claim 1, wherein the device (200) includes an imaging unit (108) configured to capture an image based upon the input from the user.

4. The system (100) as claimed in claim 1, wherein the projecting device (200) is any or a combination of a smart phone, camera.

5. The system (100) as claimed in claim 1, wherein the input unit (106) provides an interface to the user for providing the at least one input.

6. The system (100) as claimed in claim 1, wherein the digital content processing unit (110) is configured to evaluate pixel data based upon processing of the digital content.

7. The system (100) as claimed in claim 1, wherein the sensing unit (112) includes a plurality of sensors for monitoring the ambient environment condition, the ambient environment condition is any or a combination of light, temperature, pressure, humidity, distance.

8. The system (100) as claimed in claim 1, wherein the projecting unit (114) includes a thermal projection sub-unit (114a) and a photonic projection sub-unit (114b).

9. The system (100) as claimed in claim 1, wherein the printable substrate (202) is any or a combination of a carbonized paper, photosensitive paper.

10. The system (100) as claimed in claim 8, wherein the projecting unit (114) is configured to project any or a combination of a thermal projection rays, a photonic projection rays on to the printable substrate (202), wherein a selection of the projection rays is based upon inputs from the digital content processing unit (110) and the sensing unit (112).

11. A projecting device (200) configured to project a digital content, said device (200) includes:
a memory (102) for storing instructions,
a processor (104) coupled to the memory (102),
an input unit (106) configured to receive at least one input corresponding to the digital content from a user,
an digital content processing unit (110) configured to process the digital content,
a sensing unit (112) configured to monitor an ambient environment condition, and
a projecting unit (114) configured to project the processed digital content,
wherein, the projecting device (200) is configured to project the processed digital content on to a printable substrate (202) configured to receive and imprint the projected digital content.

12. The device (200) as claimed in claim 11, wherein the projecting unit (114) includes a thermal projection sub-unit (114a) and a photonic projection sub-unit (114b), and the printable substrate (202) is any or a combination of a carbonized paper, photosensitive paper, and wherein the projecting unit (114) is configured to project any or a combination of a thermal projection rays, a photonic projection rays on to the printable substrate (202), wherein a selection of the projection rays is based upon inputs from the digital content processing unit (110) and the sensing unit (112).
